(19) United States
(12) Patent Application Publication
(10) Pub. No.: US 2007/0229752 A1
(43) Pub. Date: Oct. 4, 2007

(54) Liquid crystal display apparatus

(76) Inventor: Wei-Hsiao Chen, Tainan (TW)

Correspondence Address: J.C. Patents, Inc., Suite 250, 4 Venture, Irvine, CA, 92618, US

(21) Appl. No.: 11/440,640

(22) Filed: May 24, 2006

(30) Foreign Application Priority Data
Apr. 4, 2006 (TW) 95111894

(51) Int. Cl. G02F 1/1345

(52) U.S. Cl. 349/152

(57) ABSTRACT

A liquid crystal display apparatus having a lower substrate, an upper substrate, a liquid crystal layer and a protection configuration is provided. The lower substrate includes a first substrate, a pixel array and a patterned circuit. The first substrate has a display area and a peripheral circuit area. The pixel array is disposed in the display area on the first substrate. The patterned circuit is disposed in the peripheral circuit area on the first substrate and are electrically connected to the pixel array. The upper substrate is disposed over the lower substrate. The liquid crystal layer is disposed between the lower substrate and the upper substrate. The protection configuration partially covers the patterned circuit. Accordingly, a liquid crystal display apparatus that can prevent the patterned circuit from being damaged during a breaking process is provided.

### CROSS-REFERENCE TO RELATED APPLICATION

This application claims the priority benefit of Taiwan application serial no. 95111894, filed on Apr. 4, 2006. All disclosure of the Taiwan application is incorporated herein by reference.

### BACKGROUND OF THE INVENTION

1. Field of the Invention

The present invention relates to a display apparatus, and more particularly, relates to a liquid crystal display apparatus.

2. Description of Related Art

In recent years, liquid crystal display apparatus have been adopted in many types of electronic products to serve as the screens/panels of liquid crystal television, portable computers, desktop computers as well as liquid crystal projectors. In particular, liquid crystal projector has become one of the indispensable tools for a large display. At the core of the liquid crystal projector is an optical engine used for projecting images lies. The optical engine mainly includes a light source, an optical device comprising a few sets of prisms and a plurality of liquid crystal panels that correspond to each of the optical paths (red, green and blue). The foregoing liquid crystal panels are mostly liquid crystal on silicon (LCOS) panels. The LCOS panel is a type of reflective liquid crystal panel built on a silicon substrate. Because the LCOS panel is built on a silicon substrate, which occupies a small volume and has a relatively high resolution, its application as a liquid crystal projector is quite common. Furthermore, the technology of the LCOS panel also matches the demand for reducing the bulk of a liquid crystal projector.

FIG. 1 is a schematic cross-sectional view of a conventional LCOS panel. The LCOS panel 40 mainly comprises a lower substrate 10, an upper substrate 20, a sealant 32 and a liquid crystal layer 34. The upper substrate 20 is disposed over the lower substrate 10 and the sealant 32. The liquid crystal layer 34 is disposed between the lower substrate 10 and the upper substrate 20. The liquid crystal layer 34 is located within the area enclosed by the sealant 32.

The lower substrate 10 further includes a silicon substrate 11, a pixel array 12, a patterned circuit 14 and a plurality of bonding pads 15. The silicon substrate 11 is divided into a display area 11a and a peripheral circuit area 11b. The pixel array 12 is disposed on the silicon substrate 11 and located within the display area 11a. The patterned circuit 14 is located in the peripheral circuit area 1 lb on the silicon substrate 10 and are electrically connected to the pixel array 12. The bonding pads 15 are located in the peripheral circuit area 11b and are electrically connected to the patterned circuit 14. The upper substrate 20 includes a transparent substrate 21 and an indium tin oxide (ITO) electrode 22 disposed thereon.

FIG. 2A is a schematic cross-sectional view showing the structure of a conventional LCOS panel before performing a breaking process. In general, the process of fabricating a conventional LCOS panel 40 includes coating a plurality of sealants 32 on a silicon wafer substrate 11′ having a plurality of pixel arrays 12, a plurality of patterned circuit 14 and a plurality of bonding pads 15 already formed thereon. Then, liquid crystal layers 34 are formed within the areas enclosed by the sealants 32, and a large transparent substrate 21′ with indium-tin-oxide electrodes 22′ formed thereon is attached thereafter. Next, a scribing knife is used to cut away a portion of the thickness of the silicon wafer substrate 11′ and the large transparent substrate 21′.

FIG. 2B is a schematic cross-sectional view showing the structure of a conventional LCOS panel during performing a breaking process. After cutting the silicon wafer substrate 11′ and the large transparent substrate 21′ to a definite thickness with a scribing knife, a breaking process is executed to produce individual LCOS panels 40. Because the peripheral circuit area 11b of the silicon substrate 11 must be exposed to facilitate subsequent electrical bonding to other carrier such as a print circuit board (PCB) via the bonding pads 15, the scribe line on the silicon wafer substrate 11′ and that of the large transparent substrate 21′ cannot be aligned to the same vertical line. Since the scribe lines of the silicon wafer substrate 10′ and the large transparent substrate 21′ are not aligned to the same vertical line, the upper substrate 20 may press down and damage the patterned circuit 14 on the adjacent peripheral circuit area 11b through an inappropriate use of force in the breaking process. As a result, the LCOS panel 40 may be permanently damaged so that the throughput of the LCOS panel 40 can not be effectively controlled. Accordingly, the production cost remains high.

### SUMMARY OF THE INVENTION

Accordingly, at least one objective of the present invention is to provide a liquid crystal display apparatus capable of preventing patterned circuit from being damaged during a breaking process.

To achieve these and other advantages and in accordance with the purpose of the invention, as embodied and broadly described herein, the invention provides a liquid crystal display apparatus. The liquid crystal display apparatus includes a lower substrate, an upper substrate, a liquid crystal layer and a protection configuration is provided. The lower substrate includes a first substrate, a pixel array and at least one patterned circuit. The first substrate has a display area and a peripheral circuit area. The pixel array is disposed in the display area on the first substrate. The patterned circuit is disposed in the peripheral circuit area on the first substrate and are electrically connected to the pixel array. The upper substrate is disposed over the lower substrate. The liquid crystal layer is disposed between the lower substrate and the upper substrate. The protection configuration partially covers the patterned circuit.

According to one embodiment of the present invention, the liquid crystal apparatus further includes a sealant located between the lower substrate and the upper substrate and surrounded the liquid crystal layer.

According to one embodiment of the present invention, the lower substrate further includes a color filter array disposed on the pixel array. The upper substrate further includes a second substrate and a common electrode. The common electrode is disposed on the surface of the second substrate facing the lower substrate.

According to one embodiment of the present invention, the foregoing first substrate is a silicon substrate and the protection configuration and the patterned circuit is isolated from each other through an insulation layer.

According to one embodiment of the present invention, the foregoing protection configuration is fabricated using resinous material.

According to one embodiment of the present invention, the foregoing protection configuration is fabricated using a material selected from a group consisting of a red color filter, a green color filter, a blue color filter and a combination thereof.

According to one embodiment of the present invention, the foregoing color filter array is selected from a group consisting of a red color filter, a green color filter, a blue color filter and a combination thereof.

According to one embodiment of the present invention, the foregoing upper substrate includes a second substrate, a common electrode and a color filter array. The common electrode is disposed on the surface of the second substrate facing the lower substrate. The color filter array is disposed between the common electrode and the second substrate. In addition, the protection configuration and the patterned circuit is isolated from each other through an insulation layer.

According to one embodiment of the present invention, the lower substrate and the upper substrate are disposed with a displacement configuration. The edge of the lower substrate is displaced from the edge of the upper substrate a distance between 1200 μm to 1800 μm. In another embodiment, the edge of the substrate is shifted from the edge of the upper substrate a distance of about 1500 μm.

In the liquid crystal display apparatus of the present invention, the protection configuration is able to protect the patterned circuit on the adjacent peripheral circuit area so that the patterned circuit will not be damaged. Therefore, the liquid crystal display apparatus in the present invention can have a higher throughput and a lower fabrication cost.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a conventional LCOS panel.

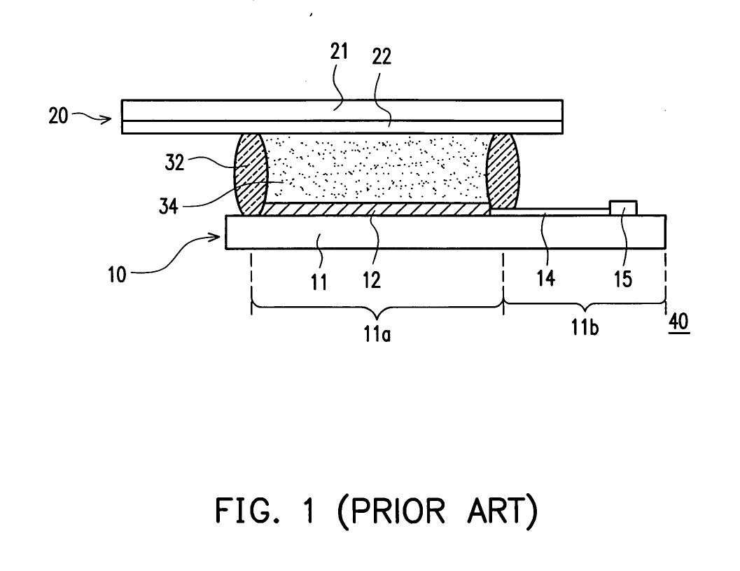

FIG. 2A is a schematic cross-sectional view showing the structure of a conventional LCOS panel before performing a breaking process.

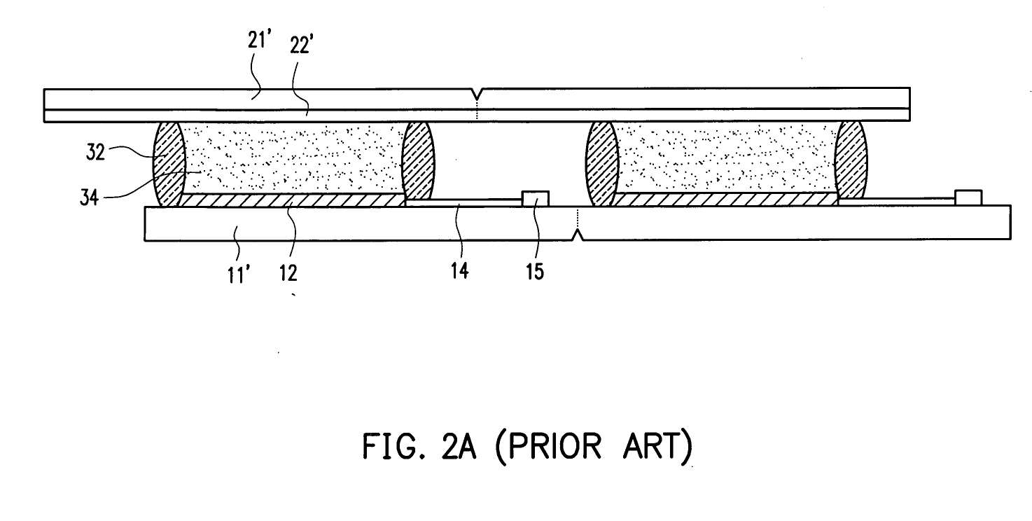

FIG. 2B is a schematic cross-sectional view showing the structure of a conventional LCOS panel during performing a breaking process.

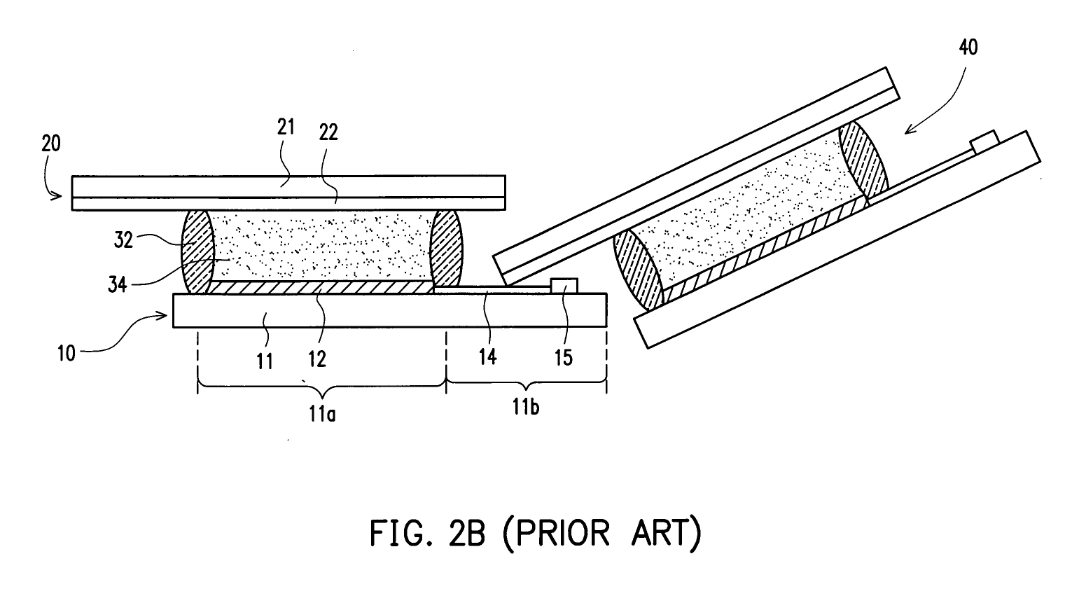

FIG. 3 is a schematic cross-sectional view of an LCOS panel according to a first embodiment of the present invention.

FIG. 4 is a schematic cross-sectional view showing the structure of an LCOS panel after performing a breaking process according to the first embodiment of the present invention.

FIG. 5 is a schematic cross-sectional view of an LCOS panel according to a second embodiment of the present invention.

FIG. 6 is a schematic cross-sectional view showing the structure of an LCOS panel after performing a breaking process according to the second embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

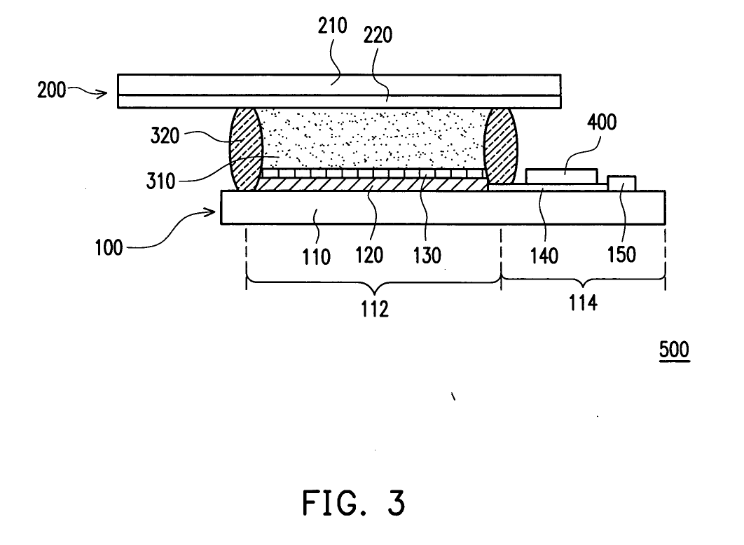

FIG. 3 is a schematic cross-sectional view of an LCOS panel according to a first embodiment of the present invention. As shown in FIG. 3, the liquid crystal display apparatus 500 includes a lower substrate 100, an upper substrate 200, a liquid crystal layer 310 and a protection configuration 400. The lower substrate 100 further comprises a first substrate 110, a pixel array 120 and a least one patterned circuit 140. The first substrate 110 has a display area 112 and a peripheral area 114. The pixel array 120 is disposed in the display area 112 on the first substrate 110. The patterned circuit 140 is disposed in the peripheral circuit area 114 on the first substrate 110 and are electrically connected to the pixel array 120. The upper substrate 200 is disposed over the lower substrate 100. The liquid crystal layer 310 is disposed between the lower substrate 100 and the upper substrate 200. The protection configuration 400 partially covers the patterned circuit 140 such that the protection configuration 400 is isolated from the patterned circuit 140 through a thin insulation layer (not shown, for example, a silicon insulation layer).

In the present embodiment, the lower substrate 100 further includes a color filter array 130. The color filter array 130 is disposed on the pixel array 120. The upper substrate 200 includes a second substrate 210 and a common electrode 220. The common electrode 220 is disposed on the surface of the second substrate 210 facing the lower substrate 100. In addition, the liquid crystal display apparatus 500 also includes a sealant 320 disposed between the lower substrate 100 and the upper substrate 200 and surrounding the liquid crystal layer 310.

The first substrate 110 is a silicon substrate and the second substrate 210 is a glass substrate, a quartz substrate or a transparent substrate fabricated using a suitable material, for example. The pixel array 120 includes, for example, a plurality of scan lines, a plurality of data lines, a plurality of active devices and a plurality of pixel electrodes. Each of the active devices is electrically connected to a corresponding scan line and data line and each of the pixel electrodes is electrically connected to a corresponding active device. The patterned circuit 140 is, for example, integrated circuit (IC), driving circuits, timing controller or a plurality of conductive lines electrically connected to a plurality of bonding pads 150 located in the peripheral circuit area 114 on the first substrate 110. The color filter array 130 includes, for example, a plurality of red color filters, green color filters or blue color filters or a combination thereof. The common electrode 220 is fabricated using, for example, indium tin oxide (ITO), indium zinc oxide (IZO) or other suitable transparent conductive material. Furthermore, according to the foregoing description, the liquid crystal display apparatus 500 in the present embodiment is an LCOS panel.

More specifically, the protection configuration 400 is fabricated using a resin or other suitable material (for example, a material selected from a red color filter, a green color filter, a blue color filter or a combination thereof). The protection configuration 400 is formed together with the color filter array 130 and has a thickness of about 1 μm, for example. To facilitate the connection of the bonding pads 150, electrically connected to the patterned circuit 140, with other carrier, the lower substrate 100 is oriented in a displacement configuration with respect to the upper substrate 200. The edge of the lower substrate 100 is displaced from the corresponding edge of the upper substrate 200 a distance between 1200 μm to 1800 μm, for example. In another embodiment, the edge of the lower substrate 100 is shifted from the edge of the upper substrate 200 a distance of about 1500 μm, for example.

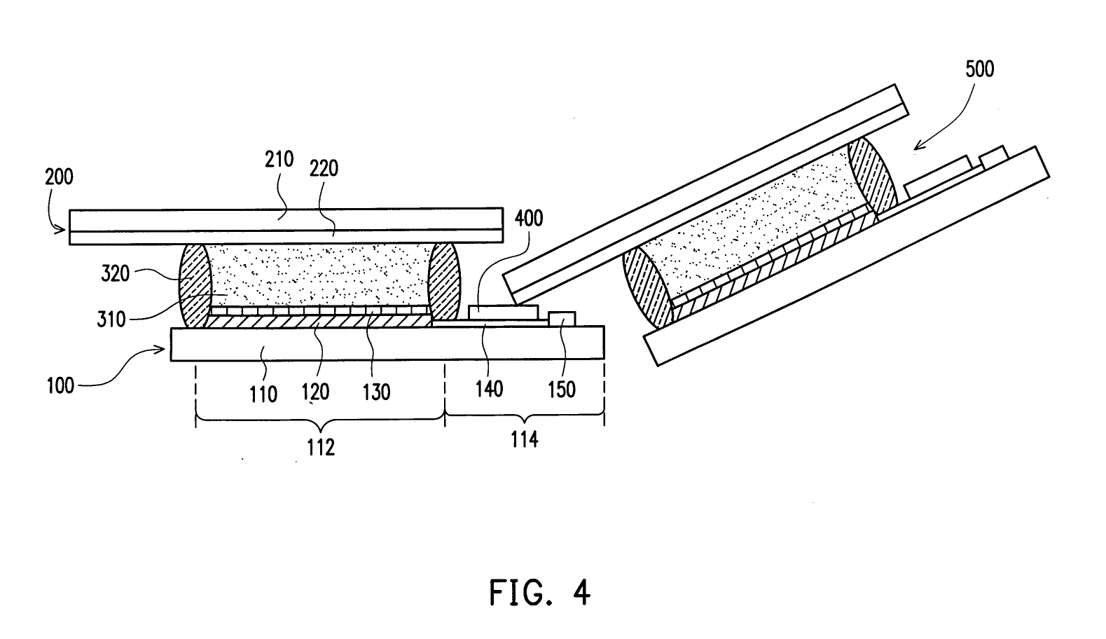

The method of fabricating the foregoing liquid crystal display apparatus 500 is very similar to that of fabricating the conventional LCOS panel 40. Hence, a detailed description is omitted. However, it should be noted that after performing the cutting process, a breaking process is still required to produce a plurality of individual liquid crystal display apparatuses 500. FIG. 4 is a schematic cross-sectional view showing the structure of an LCOS panel during performing a breaking process according to the first embodiment of the present invention. Although the breaking process may lead to a downward tilting of the upper substrate 200 when an inappropriate amount of force is applied, the protection configuration 400 is able to protect the patterned circuit 140 on the adjacent peripheral circuit area 114 against possible damages. Therefore, the number of mal-functional liquid crystal display apparatuses 500 will be reduced. Since the throughput of the liquid crystal display apparatuses 500 can be effectively controlled, the cost of production is also lowered.

It should be noted that although the first substrate 110 is a silicon substrate in the present embodiment, the first substrate 110 is not limited to a silicon substrate. The first substrate 110 can be fabricated using other suitable material.

### Second Embodiment

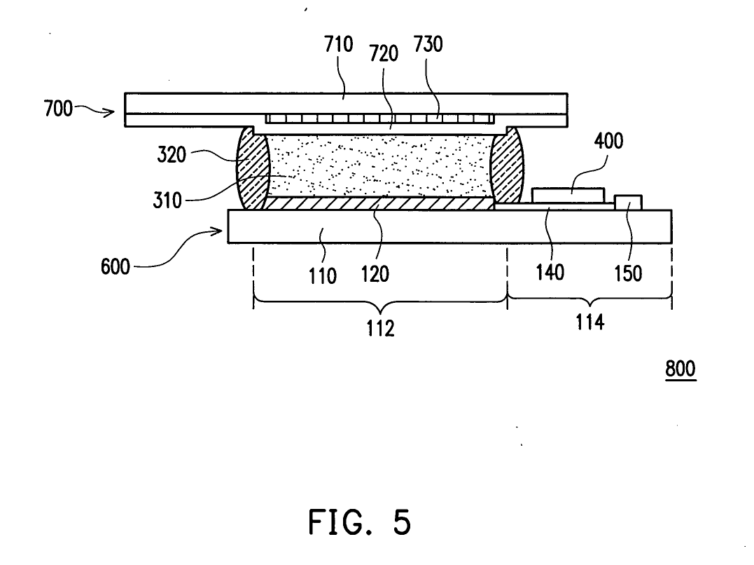

FIG. 5 is a schematic cross-sectional view of an LCOS panel according to a second embodiment of the present invention. As shown in FIG. 5, the liquid crystal display apparatus 800 in the present embodiment is very similar to the liquid crystal display apparatus 500 in the first embodiment. In the liquid crystal display apparatus 800, the first substrate 110 is, for example, a glass substrate, a quartz substrate or a substrate fabricated using suitable material. The upper substrate 700 includes a second substrate 710, a common electrode 720 and a color filter array 730. The common electrode 720 is disposed on the surface of the second substrate 710 facing the lower substrate 600. The color filter array 730 is disposed between the second substrate 710 and the common electrode 720.

More specifically, the protection configuration 400 is fabricated using a material identical to the first embodiment. The color filter array 730 includes, for example, a plurality of red color filters, green color filters or blue color filters or a combination thereof. The common electrode 720 is fabricated using, for example, indium tin oxide, indium zinc oxide or other suitable transparent conductive material. The liquid crystal display apparatus 800 is, for example, a thin film transistor liquid crystal display (TFT LCD).

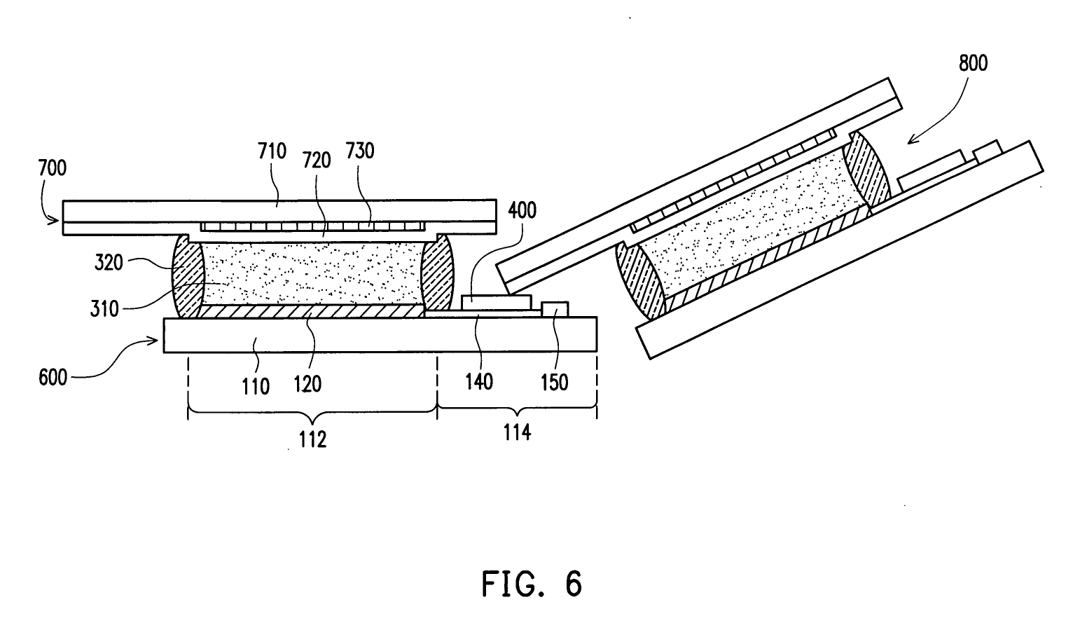

FIG. 6 is a schematic cross-sectional view showing the structure of an LCOS panel during performing a breaking process according to the second embodiment of the present invention. As shown in FIG. 6, similar to the liquid crystal display apparatus 500 in the first embodiment, the protection configuration 400 of the liquid crystal display apparatus 800 protects the pattern circuits 140 on the adjacent peripheral circuit area 114 so that damages to the patterned circuit 140 is minimized. The protection configuration 400 is isolated from the patterned circuit 140 through a thin insulation layer (not shown, for example, a silicon insulation layer). Therefore, the number of mal-functional liquid crystal display apparatuses 800 will be reduced. Since the throughput of the liquid crystal display apparatuses 800 can be effectively controlled, the cost of production is also lowered.

In summary, the protection configuration in the liquid crystal display apparatus of the present invention protects the patterned circuit on the adjacent peripheral circuit area during the breaking process so that the patterned circuit will remain intact. Hence, the liquid crystal display apparatus can have a higher throughput and a lower production cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid crystal display apparatus, comprising:
a lower substrate, having:
a first substrate, having a display area and a peripheral circuit area;
a pixel array, disposed in the display area on the first substrate;
a patterned circuit, disposed in the peripheral circuit area on the first substrate and electrically connected to the pixel array;
an upper substrate, disposed over the lower substrate;
a liquid crystal layer, disposed between the lower substrate and the upper substrate; and
a protection configuration, partially covering the patterned circuit.

2. The liquid crystal display apparatus of claim 1 further comprising a sealant located between the lower substrate and the upper substrate and surrounded the liquid crystal layer.

3. The liquid crystal display apparatus of claim 1, wherein the lower substrate further comprises a color filter array disposed on the pixel array.

4. The liquid crystal display apparatus of claim 3, wherein the upper substrate further comprises:
a second substrate; and
a common electrode, disposed on the surface of the second substrate facing the lower substrate.

5. The liquid crystal display apparatus of claim 4, wherein the first substrate comprises a silicon substrate.

6. The liquid crystal display apparatus of claim 5, wherein the protection configuration is isolated from the patterned circuit through an insulation layer.

7. The liquid crystal display apparatus of claim 3, wherein the protection configuration is made of resin.

8. The liquid crystal display apparatus of claim 3, wherein the protection configuration is made of a material selected from a group consisting of red color filter, green color filter, blue color filter and a combination thereof.

9. The liquid crystal display apparatus of claim 8, wherein the color filter array is selected from a group consisting of red color filter, green color filter, blue color filter and a combination thereof.

10. The liquid crystal display apparatus of claim 1, wherein the upper substrate comprises:
a second substrate;
a common electrode, disposed on the surface of the second substrate facing the lower substrate; and
a color filter array, disposed between the common electrode and the second substrate.

11. The liquid crystal display apparatus of claim 10, wherein the protection configuration is isolated from the patterned circuit through an insulation layer.

12. The liquid crystal display apparatus of claim 10, wherein the protection configuration is made of resin.

13. The liquid crystal display apparatus of claim 10, wherein the protection configuration is made of a material selected from a group consisting of red color filter, green color filter, blue color filter and a combination thereof.

14. The liquid crystal display apparatus of claim 13, wherein the color filter array is selected from a group consisting of red color filter, green color filter, blue color filter and a combination thereof.

15. The liquid crystal display apparatus of claim 1, wherein the protection configuration has a thickness of about 1 μm.

16. The liquid crystal display apparatus of claim 1, wherein the lower substrate is oriented in a displacement configuration with respect to the upper substrate.

17. The liquid crystal display apparatus of claim 16, wherein the edge of the lower substrate is displaced from the edge of the upper substrate a distance between 1200 μm to 1800 μm.
